(19) United States
(12) Patent Application Publication
(10) Pub. No.: US 2018/0136530 A1
(43) Pub. Date: May 17, 2018

(54) ELECTROCHROMIC ELEMENT, OPTICAL FILTER USING THE SAME, LENS UNIT, IMAGING DEVICE, WINDOW MATERIAL, AND METHOD FOR DRIVING ELECTROCHROMIC ELEMENT

(71) Applicant: CANON KABUSHIKI KAISHA, Tokyo (JP)

(72) Inventors: Jun Yamamoto, Tokyo (JP); Kazuya Miyazaki, Kunitachi-shi (JP)

(21) Appl. No.: 15/808,778

(22) Filed: Nov. 9, 2017

(30) Foreign Application Priority Data
Nov. 17, 2016 (JP) 2016-224387
Sep. 1, 2017 (JP) 2017-168462

(51) Int. Cl. G02F 1/163; G02F 1/155; G02F 1/15; G02B 7/04

(52) U.S. Cl. CPC G02F 1/163; G02B 7/04; G02F 1/1521; G02F 1/155

(57) ABSTRACT

An electrochromic device of the present disclosure includes an electrochromic element including an anode, a cathode, and an electrochromic layer disposed between the anode and the cathode and a drive device connected to the electrochromic element. In the electrochromic device described above, the anode and the cathode include a plurality of pairs of electricity feeding portions, the pairs of electricity feeding portions are disposed so that straight lines which are drawn to pass through the pairs of electricity feeding portions are intersected with each other, and the drive device supplies different drive signals to the pairs of electricity feeding portions.

### BACKGROUND

### Field of the Disclosure

The present disclosure relates to an electrochromic element, an optical filter using the same, a lens unit, an imaging device, a window material, and a method for driving an electrochromic element.

### Description of the Related Art

A compound which changes its optical characteristics, such as its absorption wavelength and absorbance, by an electrochemical oxidation-reduction reaction is called an electrochromic (hereinafter, referred to as “EC” in some cases) compound. An electrochromic element (EC element) using this EC compound is used for a display device, a variable reflectance mirror, a variable transmission window, or the like.

Among EC elements each formed of an organic EC compound, there is a so-called complementary EC element including an EC layer formed of an EC solution in which an anodic EC material to be colored by oxidation and a cathodic EC material to be colored by reduction are contained. When the EC element as described above is driven for a long time while an in-plane direction of an electrode of the EC element is set along a vertical direction, a phenomenon (segregation) in which the anodic EC material and the cathodic EC material are separated from each other in the EC layer may occur in some cases.

U.S. Pat. No. 6,016,215 (hereinafter, referred to as “Patent Document 1”) has disclosed that this segregation along a vertical direction is believed to be caused by the difference in tendency of solvation between cations and anions with a non-aqueous solvent. Cations have a high solvation with a non-aqueous solvent and are strongly bonded to solvent molecules, so that the specific gravity of the solvent around cations is increased as compared to the specific gravity of the solvent itself. On the other hand, since anions have a low solvation, the specific gravity of the solvent around anions is decreased as compared to the specific gravity of the solvent itself. By the difference in specific gravity as described above, an anodic EC coloring species is localized at a lower side in a vertical direction, and a cathodic EC coloring species is localized at an upper side in a vertical direction, so that the segregation caused by the influence of the specific gravity occurs. When the segregation occurs, if the EC layer is desired to be put in a decolored state, a decoloration response of the EC layer is degraded, and a time required for decoloration may unfavorably take a long time in some cases.

Japanese Patent Laid-Open No. 9-120088 (hereinafter, referred to as “Patent Document 2”) has disclosed that by addition of a polymer matrix to an EC solution, the viscosity of the EC solution is increased. In Patent Document 2, by the increase in viscosity of the EC solution, EC compounds and materials, such as oxidizing and reducing materials, to be involved in an oxidation-reduction reaction of the EC compounds are suppressed from transferring, so that the segregation is suppressed from being generated.

However, when the viscosity of the EC solution is increased as disclosed in Patent Document 2, a time required for coloration and a time required for decoloration are both increased, and as a result, the response of the EC element may be degraded in some cases. The reason for this is that the response of the EC element is influenced by a diffusion rate of the EC compound contained in the EC solution to an electrode surface.

### SUMMARY

The present disclosure provides an electrochromic element in which a charge balance in an electrochromic layer is improved. An electrochromic device according to one aspect of the present disclosure provides an electrochromic device comprising: an electrochromic element which includes an anode, a cathode, and an electrochromic layer disposed between the anode and the cathode as well as a drive device connected to the electrochromic element, wherein the anode and the cathode have a plurality of pairs of electricity feeding portions, and the plurality of pairs of electricity feeding portions are disposed so that when straight lines passing through the pairs of electricity feeding portions are drawn, the straight lines are intersected with each other, and the drive device supplies drive signals different from each other to the plurality of pairs of electricity feeding portions.

Further features of the present disclosure will become apparent from the following description of exemplary embodiments with reference to the attached drawings.

### BRIEF DESCRIPTION OF THE DRAWINGS

FIGS. 1A and 1B are schematic views each illustrating the structure of an electrochromic device according to an embodiment of the subject disclosure.

FIGS. 2A and 2B are schematic views each illustrating the structure of an electrochromic device according to an embodiment of the subject disclosure.

FIGS. 3A and 3B are schematic views each illustrating a voltage application method according to an embodiment of the subject disclosure.

FIGS. 4A and 4B are schematic views each illustrating a voltage application method according to an embodiment of the subject disclosure.

FIGS. 5A and 5B are schematic views each illustrating the structure of an imaging device according to an embodiment of the subject disclosure.

FIGS. 6A and 6B are schematic views each illustrating the structure of a window material according to an embodiment of the subject disclosure.

FIG. 7 is a graph showing gray scales of Examples and Comparative Examples.

FIGS. 8A and 8B are schematic views each illustrating a different example of the voltage application method according to an embodiment of the subject disclosure.

### DESCRIPTION OF THE EMBODIMENTS

An electrochromic device according to an embodiment has electricity feeding portions to which different drive signals are to be applied. Since a drive signal to be applied can be changed in accordance with the position of an electrochromic element, the charge balance in an electrochromic layer can be improved.

Furthermore, at an upper side of the electrochromic element in a gravity direction, since an oxidation reaction is frequently induced, the segregation can be suppressed. In particular, the case in which an electrode located at an upper side in a gravity direction is used as an anode may be mentioned.

The electrochromic device of this embodiment comprises: an electrochromic element which includes an anode, a cathode, an electrochromic layer which is provided between the anode and the cathode and which at least partially has an effective light region; and a drive device controlling the amount of light passing through the effective light region. In this electrochromic element, anode terminals which form a pair are connected to respective end portions of the anode facing each other, cathode terminals which form a pair are connected to respective end portions of the cathode facing each other, one anode terminal and one cathode terminal facing each other with the effective light region interposed therebetween form a first terminal pair, and the other anode terminal and the other cathode terminal facing each other with the effective light region interposed therebetween form a second terminal pair. By the drive device, the voltage is applied to the first terminal pair and the second terminal pair so that at least a part of a first application period in which the voltage applied to the first terminal pair and at least a part of a second application period in which the voltage is applied to the second terminal pair are not overlapped with each other. In addition, the electrochromic device described above is used in such a way that one anode terminal of one of the first terminal pair and the second terminal pair is disposed at a position higher than that of the cathode terminal of the one of the terminal pairs in a vertical direction, and the anode terminal of the other terminal pair is disposed at a position lower than that of the cathode terminal of the other terminal pair, and by the drive device described above, a charge amount generated when the anode terminal of the one terminal pair is used as a plus electrode can be made larger than a charge amount generated when the anode terminal of the other terminal pair is used as a plus electrode.

According to the electrochromic device of this embodiment, one of the pairs of electricity feeding portions may be driven, and when the above one of the pairs of electricity feeding portions is driven, the other pair thereof may be not driven.

Hereinafter, with reference to the drawings, an organic EC device of the present disclosure will be described by way of example using preferable embodiments. However, unless otherwise particularly noted, the structure, the relative disposition, and the like described in the embodiments are not intended to limit the scope of the present disclosure.

### First Embodiment

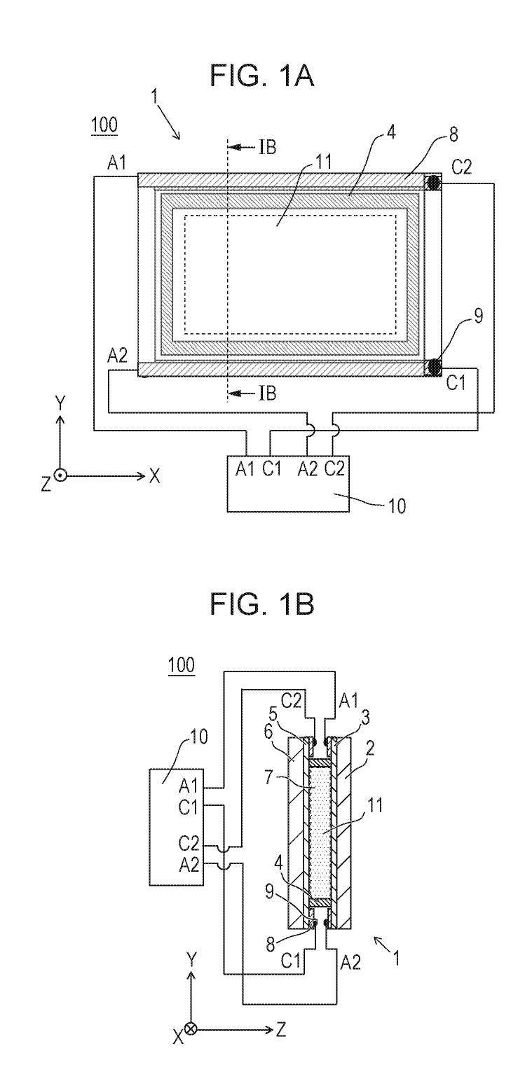

An EC device 100 of this embodiment will be described with reference to FIGS. 1A and 1B. FIGS. 1A and 1B are schematic views each illustrating the structure of the EC device 100. FIG. 1A is a top plan view of an EC element 1 having an approximately square outer shape, and FIG. 1B is a cross-sectional view taken along the line IB-IB of FIG. 1A. In addition, a lamination direction of electrodes 3 and 5 and an EC layer 7 is defined as a Z direction, a long side direction of the EC element 1 in a plane orthogonal to the Z direction is defined as an X direction, and a short side direction is defined as a Y direction.

A disposition in which when straight lines passing through pairs of electricity feeding portions are drawn, the pairs of electricity feeding portions are disposed so that the straight lines are intersected with each other indicates a disposition as shown in FIG. 1B. In particular, in FIGS. 1B, A1, C1, A2, and C2 are disposed so that a straight line passing through A1 and C1 and a straight line passing through A2 and C2 are intersected with each other. The straight lines are not shown. Some of A1, C1, A2, and C2 may be disposed at a central side of a substrate.

The EC device 100 comprises the EC element 1 and a drive device 10. The structures thereof will be respectively described.

### [EC Element]

The EC element 1 includes substrates 2 and 6 on which electrode films functioning as the electrodes 3 and 5, respectively, are formed, a spacer 4, and an electrochromic layer (EC layer) 7 disposed between the electrodes 3 and 5. In addition, the EC element 1 includes two low resistance wires 8 disposed on each of the electrodes 3 and 5 and four terminals (electrode lead portions) 9. The EC element 1 has the structure in which a pair of the substrates 2 and 6 are adhered to each other so that the electrodes 3 and 5 face each other with the spacer 4 interposed therebetween, and the EC layer 7 is present in a space formed by the pair of the electrodes 3 and 5 and the spacer 4. In this embodiment, the electrodes 3 and 5 are used as an anode and a cathode, respectively. In addition, the EC element 1 may include at least the electrodes 3 and 5 and the EC layer 7 interposed therebetween and may include no substrates 2 and 6.

The EC layer 7 contains at least one type of anodic EC material and at least one type of cathodic EC material. By application of the voltage between the electrodes 3 and 5, the EC materials each induce an electrochemical reaction. In addition, the EC layer 7 is not limited to have the structure in which at least one type of anodic EC material and at least one type of cathodic EC material are contained and may have the structure in which at least one type of anodic EC material or at least one type of cathodic EC material is contained, and the other type of material may be not contained. In this case, instead of an anodic EC material or cathodic EC material which is not contained in the EC layer 7, the EC layer 7 preferably contains an electrochemical active compound which induces an oxidation-reduction reaction but is not colored thereby. In addition, the structure is preferable in which on an electrode facing an electrode on which the EC material is allowed to react, the above electrochemical active compound functions to receive and release electrons.

In general, when the voltage is not applied, a low molecular weight organic EC material is put in a neutral state and has no absorption in a visible light region. In the decolored state as described above, the organic EC material has a high transmittance. When the voltage is applied between the two electrodes, an electrochemical reaction occurs in the organic EC material, and the neutral sate is changed into an oxidized state (cations) or a reduced state (anions). The organic EC material has an absorption in the visible light region in the form of cations or anions and hence, is colored. In the colored state as described above, the organic EC material has a low transmittance. In addition, as is a viologen derivative, there may also be used a material which forms a transparent dication structure in an initial state and is colored by the formation of radical species by one-electron reduction.

Hereinafter, the transmittance of the EC element 1 will be discussed using the absorbance of the EC element 1. The transmittance and the absorbance has the following relationship, so that as the transmittance is decreased by one half, the absorbance is increased by approximately 0.3. −Log (transmittance)=(absorbance)

### <Substrate>

When the EC element 1 is used as a dimming element, in order to reduce the influence on an optical system, a high transmittance is preferably maintained in a decolored state. Hence, the substrates 2 and 6 are each preferably a transparent substrate through which visible light is allowed to sufficiently pass; hence, in general, a glass material is used, and an optical glass substrate, such as Corning #7059 or BK-7, may be preferably used. In addition, as long as having a sufficient transparency, a material, such as a plastic or a ceramic, may also be appropriately used. In addition, the “transparency” in this embodiment represents a visible light transmittance of 90% or more.

As the substrates 2 and 6, a rigid material not likely to generate strain is preferably used. In addition, as the substrates 2 and 6, a substrate having a low flexibility is more preferable. The thicknesses of the substrates 2 and 6 are each, in general, several tens of micrometers to several millimeters.

### <Electrode>

When the EC element 1 is used as a dimming element, in order to reduce the influence on an optical system, a high transmittance is preferably maintained in a decolored state. Hence, the electrodes 3 and 5 are each preferably a transparent electrode through which visible light is allowed to sufficiently pass and are each preferably formed of a material having not only a high optical transparency in the visible light region but also a high electrical conductivity. As materials for the electrodes 3 and 5, for example, there may be mentioned a metal and/or a metal oxide, such as an indium tin oxide (ITO) alloy, tin oxide (NESA), indium zinc oxide (IZO (registered trade name)), silver oxide, vanadium oxide, molybdenum oxide, gold, silver, platinum, copper, indium, or chromium; a silicon material, such as polycrystalline silicon or amorphous silicon; or a carbon material, such as carbon black, graphene, graphite, or glassy carbon.

In addition, as the electrodes 3 and 5, there may be preferably used an electrically conductive polymer (such as a polyaniline, a polypyrrole, a polythiophene, a polyacetylene, a polyparaphenylene, or a complex (PEDOT:PSS) of a poly(ethylene dioxythiophene) and a poly(styrene sulfonic acid) in which the electrical conductivity is improved, for example, by a doping treatment. In the EC element 1 of this embodiment, since a compound having a high transmittance in a decolored state is preferable, for example, ITO, IZO (registered trade name), NESA, PEDOT:PSS, or graphene is particularly preferably used. Those compounds may have various shapes, such as a bulk form and fine particles.

In addition, those materials may be used alone, or at least two thereof may be used in combination. In addition, in this embodiment, although transparent electrodes are used for the electrodes 3 and 5, the electrodes 3 and 5 are not limited thereto. Appropriate materials may be selected in accordance with the application thereof, and for example, only one of the electrodes 3 and 5 may be formed as a transparent electrode.

### <EC Layer>

The EC layer 7 contains an electrolyte and an EC material and is preferably a solution in which an electrolyte and an organic EC material, such as a low molecular weight organic material, are dissolved in a solvent. As the EC material, an organic EC material is preferably used.

As the solvent contained in the EC layer 7, although any material may be used as long as dissolving an electrolyte, a material having a polarity is particularly preferable. In particular, for example, there may be mentioned, besides water, an organic polar solvent, such as methanol, ethanol, propylene carbonate, ethylene carbonate, dimethyl sulfoxide, dimethoxyethane, acetonitrile, γ-butyronitrile, γ-valerolactone, sulfolane, dimethylformamide, dimethoxyethane, tetrahydrofuran, propionitrile, dimethylacetamide, methylpyrrolidinone, or dioxolane.

As the electrolyte, any ion dissociative salt having a preferable solubility and containing cations or anions which have an electron-donating property so as to ensure coloration of an organic EC material may be used without any particular restriction. For example, inorganic ion salts, such as various alkali metal salts and alkaline earth metal salts, quaternary ammonium salts, and cyclic quaternary ammonium salts may be mentioned. In particular, for example, there may be mentioned alkali metal salts of Li, Na, and K, such as LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts and cyclic quaternary ammonium salts, such as (CH₃)₄NBF₄, (C₂H₅)₄NBF₄, (n-C₄H₉)₄NBF₄, (C₂H₅)₄NBr, (C₂H₅)₄NClO₄, and (n-C₄H₉)₄NClO₄. As the anion species, a generally known structure, such as ClO₄⁻, CF₃SO₃⁻, BF₄⁻, PF₆⁻, or (CF₃SO₂)₂N⁻, may be used. In addition, an ionic liquid may also be used. Those electrolyte materials may be used alone, or at least two thereof may be used in combination.

The EC layer 7 is preferably a liquid or a gel. Although the EC layer 7 is preferably used in a liquid state, a gel may also be used. In order to enable the EC layer 7 to have a gel state, for example, there may be mentioned a method in which a gelation agent, such as a polymer, is added to a solution containing an electrolyte and an organic EC material, or a method in which a solution containing an electrolyte and an organic EC material is supported on a transparent and flexible body having a network structure (such as a spongy body).

When a gelation agent is added to the solution containing an electrolyte and an organic EC material, the gelation agent is not particularly limited. For example, there may be mentioned a polyacrylonitrile, a carboxymethyl cellulose, a poly(vinyl chloride), a poly(vinyl bromide), a poly(ethylene oxide), a poly(propylene oxide), a polyurethane, a polyacrylate, a polymethacrylate, a polyamide, a polyacrylamide, a polyester, a poly(vinylidene fluoride), or Nafion. As described above, for example, a viscous or a gelled material thus prepared may be used as the EC layer 7.

In addition, besides the case in which the EC layer 7 in the mixed state as described above is used, those solutions may be supported on a transparent and flexible body having a network structure (such as a spongy structure).

The organic EC material is a material which has a solubility to a solvent and which is able to be colored and decolored by an electrochemical reaction. As the organic EC material, known oxidizing/reducing coloring organic EC materials may be used. In addition, at least two materials may be used in combination. That is, the EC element 1 of this embodiment may contain a plurality of types of EC materials.

As the organic EC material, one type of cathodic material to be colored by a reduction reaction may be used, or a plurality of types of cathodic materials may be used as a cathodic material. In addition, one type of anodic material to be colored by an oxidation reaction may be used, or a plurality of types of anodic materials may be used as an anodic material. In addition, as the organic EC materials, a single anodic material and a single cathodic material may be used in combination, or a plurality of anodic materials and a plurality of cathodic materials may be used in combination. In addition, the “plurality of types” described here represents that there is a plurality of types of materials having different chemical structures, and the “types are different” represents that the chemical structures are different from each other. The EC element 1 of this embodiment contains one type of cathodic material or a plurality of types of cathodic materials. In addition, as described above, the EC element 1 of this embodiment may contain one type of anodic material or a plurality of types of anodic materials.

As the organic EC material, for example, an organic dye, such as a bipyridine derivative including a viologen derivative, a styryl derivative, a fluoran derivative, a cyanine derivative, an anthraquinone derivative, or an aromatic amine derivative, may be used. In addition, as the organic EC material, for example, an organic metal complex, such as a metal-bipyridine complex or a metal-phthalocyanine complex, may be used. In addition, a bipyridine derivative, such as a viologen derivative, may be used as a cathodic material which is decolored in a stable dication state with counter ions and which is colored in a cation state by a one-electron reduction reaction.

As the anodic EC material, for example, there may be mentioned a thiophene derivative, a metallocene derivative, such as ferrocene, an aromatic amine derivative, such as a phenazine derivative, a triphenylamine derivative, a phenothiazine derivative, or a phenoxazine derivative, a pyrrole derivative, or a pyrazoline derivative. However, the anodic EC material to be used for the EC element 1 of this embodiment is not limited to those mentioned above.

As the cathodic EC material, for example, there may be mentioned a bipyridine derivative including a viologen derivative, an anthraquinone derivative, a ferrocenium salt-based compound, or a styryl derivative. Among those compounds mentioned above, the EC element 1 preferably contains a bipyridine derivative as the cathodic EC material.

### <Terminal>

The terminals 9 are electrode lead portions connected to the electrodes 3 and 5. The terminal 9 is disposed so as to have a contact point with the low resistance wire 8 and is connected to the drive device 10. The EC element 1 of this embodiment has four terminals 9, that is, a first anode terminal A1 and a second anode terminal A2 connected to the electrode 3 and a first cathode terminal C1 and a second cathode terminal C2 connected to the electrode 5. In the following description, the first anode terminal A1 and the second anode terminal A2 are called an A1 terminal and an A2 terminal, respectively, and the first cathode terminal C1 and the second cathode terminal C2 are called a C1 terminal and a C2 terminal, respectively.

The A1 terminal and the A2 terminal are disposed at end portions of the electrode 3 facing each other, and the C1 terminal and the C2 terminal are disposed at end portions of the electrode 5 facing each other. In addition, the A1 terminal and the C1 terminal are disposed so as to face each other with the effective light region of the EC layer 7 interposed therebetween. The A2 terminal and the C2 terminal are disposed so as to face each other with the effective light region interposed therebetween. In addition, the “effective light region of the EC layer” in this embodiment indicates a region in the EC layer 7 and is also a region through which light received by the EC element 1 is allowed to pass.

In this specification, a pair of terminals which are connected to different electrodes and which are disposed to face each other with the effective light region interposed therebetween is called a terminal pair. When the EC element 1 is driven while being set to stand along a vertical direction (Y direction), that is, while a lamination direction (Z direction) of the electrodes 3 and 5 and the EC layer 7 of the EC element 1 is set along a horizontal direction, two terminals of the terminal pair are disposed at positions different from each other in a vertical direction.

For example, in this embodiment, in the state in which the EC element 1 is set to stand along a vertical direction, the A1 terminal and the C1 terminal are disposed at different positions in a vertical direction. In addition, in the state in which the EC element 1 is set to stand along a vertical direction, the A2 terminal and the C2 terminal are disposed at different positions in a vertical direction. In addition, while the EC element 1 is set to stand along a vertical direction, the A1 terminal and the A2 terminal are preferably disposed at different positions in a vertical direction, and the C1 terminal and the C2 terminal are preferably disposed at different positions in a vertical direction.

Hence, in this embodiment, the A1 terminal and the C1 terminal form a first terminal pair A1-C1, and the A2 terminal and the C2 terminal form a second terminal pair A2-C2. In addition, in the following description, the first terminal pair A1-C1 and the second terminal pair A2-C2 will be referred to as the “A1-C1 terminals” and the “A2-C2 terminals”, respectively, in some cases.

### <Low Resistance Wire>

The low resistance wires 8 have a resistance lower than that of each of the electrodes 3 and 5 and are formed to reduce an in-plane distribution of voltage to be supplied to the electrodes 3 and 5 through the terminals 9. When a potential gradient is generated in the plane of each of the electrodes 3 and 5 in accordance with the distance from the terminal 9, in the EC element 1, an electrochemical reaction amount is varied along an in-plane direction. At a terminal having a higher potential, an electrochemical reaction of the EC material is likely to occur. Hence, when the EC element 1 is driven in a state having a high potential distribution, the reaction of the anodic EC material is liable to locally occur at an anode terminal (plus electrode) side, and the reaction of the cathodic EC material is liable to locally occur at a cathode terminal (minus electrode) side. As a result, the segregation caused by the influence of the potential distribution is unfavorably generated. In order to reduce the potential distribution in the effective light region, as shown in FIG. 1, the terminals are preferably disposed at positions along a long side so as to face each other with the effective light region interposed therebetween.

In this case, in order to reduce the segregation caused by the potential distribution in a long side direction by suppressing a potential drop in a long side direction to approximately 10 mV, the low resistance wire 8 is preferably disposed along the long side. The surface resistance of the low resistance wire 8 is preferably less than 1/100 of that of each of the electrodes 3 and 5 and more preferably less than 1/500 thereof. As the low resistance wire 8, a thin film silver wire formed by vacuum film formation or a thick film silver wire formed, for example, by screen printing or ink jet coating may be preferably used.

### [Drive Device]

The drive device 10 drives the EC element 1. The terminal 9 is formed so as to have a contact point with the low resistance wire 8 and is connected to the drive device 10. The drive device 10 applies a voltage (drive voltage) driving the EC element 1 to the electrodes 3 and 5 through the terminals 9 and the low resistance wires 8. In this case, to the electrodes 3 and 5 of the EC element, a drive pulse is applied which includes an application period in which the drive voltage is applied and a rest period in which no drive voltage is applied. In addition, in this case, the voltage driving the EC element 1 is a drive voltage at which the oxidation-reduction reaction of the EC material contained in the EC layer 7 proceeds.

The drive device 10 preferably includes (not shown) at least a waveform generation circuit which generates a drive voltage waveform and a switch circuit functioning as a switch device switching a drive voltage supply to the respective terminal pairs. The drive device 10 may further include peripheral devices, such as a power source and a regulator. In addition, a circuit mechanism to be used for measurement of a current and/or charges generated by the electrochemical reaction may also be included.

The drive device 10 may be an analog circuit as described above and may control the duty ratio of the drive pulse, the application timing, the magnitude of the drive voltage, and the like using a computer such as a CPU. In addition, a computer, such as a CPU, controlling a device in which the EC element 1 is incorporated may be used as the drive device 10.

### [Drive of EC Element]

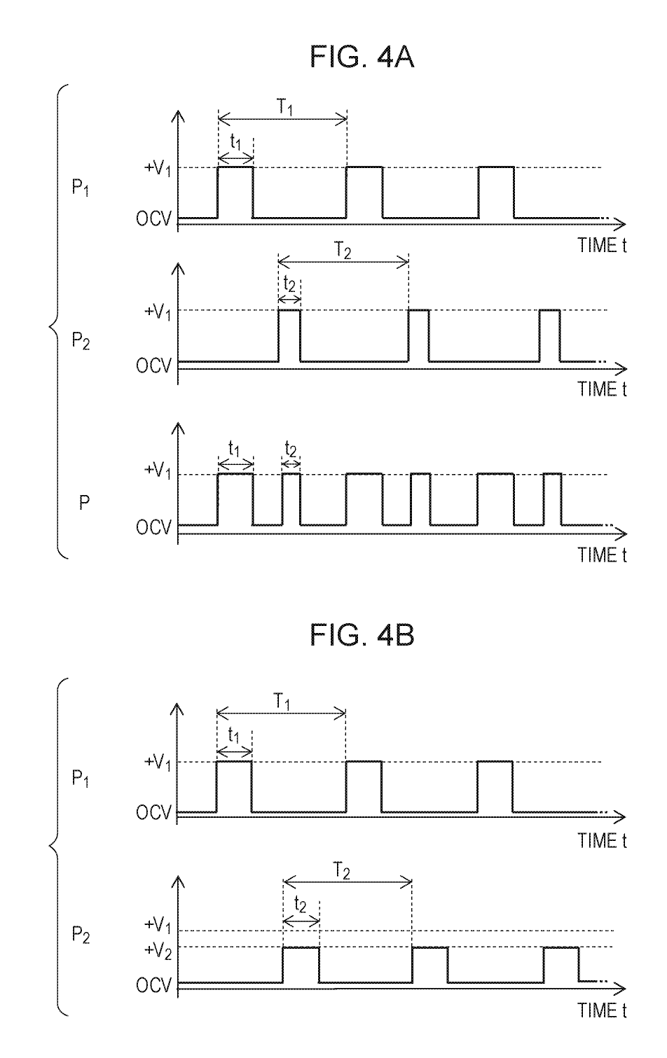

In the EC device 100 of this embodiment, the case will be described with reference to FIGS. 4A and 4B in which the EC element 1 set to stand along a vertical direction is used so that one terminal of the terminal pair of the EC element 1 is disposed at a higher position in a vertical direction than that of the other terminal. As one example of the case in which the EC element 1 set to stand along a vertical direction is used, with reference to FIGS. 4A and 4B, the case will be described in which the A1 terminal of the A1-C1 terminals is disposed at a higher position in a vertical direction, and the A2 terminal of the A2-C2 terminals is disposed at a lower side in a vertical direction.

As described above, the EC element 1 includes the two terminal pairs (the first terminal pair A1-C1 and the second terminal pair A2-C2).

The drive device 10 applies a drive voltage so that a first application period in which the drive voltage is applied to the first terminal pair A1-C1 (A1-C1 terminals) and a second application period in which the drive voltage is applied to the second terminal pair A2-C2 (A2-C2 terminals) are not overlapped with each other. In this case, since the C1 terminal of the A1-C1 terminals and the C2 terminal of the A2-C2 terminals are grounded, application voltages +V₁ having the same polarity are to be applied to the A1 terminal and the A2 terminal. That is, in this embodiment, the drive voltage is applied to the A1 terminal of the A1-C1 terminals as a plus electrode, and the drive voltage is applied to the A2 terminal of the A2-C2 terminals as a plus electrode.

One example of a waveform of the drive voltage to be applied between the A1-C1 terminals and a waveform of the drive voltage to be applied to the A2-C2 terminals is shown in FIG. 4A. The drive device 10 controls so that a first drive pulse P₁ of FIG. 4A is applied between the A1-C1 terminals and a second drive pulse P₂ of FIG. 4A is applied between the A2-C2 terminals. In this case, it can be assumed that a drive pulse P obtained by addition of the first drive pulse P₁ to the second drive pulse P₂ is applied to the entire EC element 1. The absorbance of the EC element 1 is not determined by a drive frequency f but is uniquely determined by the duty ratio. Hence, by adjusting the duty ratios of the drive pulses P₁ and P₂, the duty ratio of the drive pulse P to be applied to the EC element 1 is adjusted, so that the absorbance of the EC element 1 can be controlled. In this case, a cycle T₁ of the first drive pulse P₁ is the same as a cycle T₂ of the second drive pulse P₂.

In addition, the drive pulse includes an application period t in which a drive voltage inducing the oxidation-reduction reaction of the EC material is applied and a rest period. In this case, to this EC element 1, a voltage waveform having a crest value V₁ at a drive frequency f of 1/T and a duty ratio D of t/T is applied. In this case, the drive frequency of the drive pulse driving the EC element 1, the cycle, and the pulse width (application period) are represented by f, T, and t, respectively, and when the application period and the rest period are collectively regarded as one cycle, the duty ratio is a ratio of the application period to the one cycle.

The drive device 10 applies a drive voltage +V₁ between the A1-C1 terminals for an application period t₁. In addition, in the application period of the drive voltage +V₁ between the A2-C2 terminals, the A1-C1 terminals are maintained at an open circuit voltage (hereinafter, referred to as “OCV”). That is, the A1-C1 terminals are put in an open state in the rest period. The “maintained at an open circuit voltage” indicates that an electrical contact is disconnected between a drive power source side and the A1-C1 terminals or that a current is blocked by insertion of a high resistance component. In particular, a current is allowed to flow in the application period t₁ and is not allowed to flow in the rest period by a switch element, such as a relay or a transistor. In the application period in which +V₁ is applied, a coloration reaction occurs, and in the rest period at OCV, no coloration reaction occurs.

In the rest period including a period in which the drive voltage +V₁ is applied between the A1-C1 terminals, the A2-C2 terminals are maintained at OCV, and in the application period t₂ in which the drive voltage +V₁ is applied between the A2-C2 terminals, the drive voltage +V₁ is applied therebetween. That is, since +V₁ is applied alternately to the A1 terminal and the A2 terminal, a predetermined voltage can be applied to the EC element 1, and since the direction of potential distribution is alternately changed, the segregation caused by the influence of the potential distribution can be reduced.

As described above, in the EC element of this embodiment, when the positions of the low resistance wires 8 and the terminals 9 are appropriately selected, the potential distribution in a long side direction is reduced. However, in a related EC element, the segregation caused by the influence of the potential distribution may occur in some cases. That is, in a related driving method, in the vicinities of the terminals and the low resistance wires connected to the anode, an anodic EC material is strongly colored, and in the vicinities of the terminals and the low resistance wires connected to the cathode, a cathodic EC material is strongly colored. The segregation caused by the influence of this potential distribution is liable to be strongly generated at an early stage as compared to the segregation in a vertical direction caused by the influence of the specific gravity of the EC material.

Accordingly, in this embodiment, the two terminal pairs facing each other with the effective light region interposed therebetween are disposed, and the drive voltage is applied between the terminal pairs so that the application periods thereof are not overlapped with each other. By the structure as described above, while the same voltage is applied between the electrodes 3 and 5, the segregation caused by the potential distribution in the vicinities of the terminals 9 and the low resistance wires 8 is suppressed from being generated.

Furthermore, in the application period t₁, cations are generated at an A1 terminal side, and anions are generated at a C1 terminal side. In addition, in the application period t₂, cations are generated at an A2 terminal side, and anions are generated at a C2 terminal side. Hence, cations and anions locally present between the A1 terminal and the C2 terminal and cations and anions locally present between the A2 terminal and the C1 terminal are decolored by charge transfer. Accordingly, the reduction in segregation caused by the influence of the potential distribution can be further expected.

In addition, the drive device 10 controls so that a charge amount generated when the A1 terminal of the A1-C1 terminals disposed at a higher position in a vertical direction is used as a plus electrode is larger than a charge amount generated when the A2 terminal of the A2-C2 terminals disposed at a lower position in a vertical direction is used as a plus electrode.

For example, as shown in FIG. 4A, the drive device 10 applies the drive pulses P₁ and P₂ so that the first application period t₁ in which the drive voltage is applied between the A1-C1 terminals is longer than the second application period t₂ in which the drive voltage is applied between the A2-C2 terminals. As a result, the charge amount generated when the drive voltage is applied between the first terminal pair A1-C1 is larger than the charge amount generated when the drive voltage is applied between the second terminal pair A2-C2.

By the structure formed as described above, when the EC element 1 set to stand along a vertical direction is driven, the variation of concentration caused by the influence of the specific gravity can be reduced. The reduction in variation of concentration caused by the influence of the specific gravity will be described.

In the case in which the first application period t₁ is the same as the second application period t₂, and the same drive voltage is applied between the A1-C1 terminals and the A2-C2 terminals, the concentration of cations and the concentration of anions generated between the A1-C1 terminals and the A2-C2 terminals are the same or closest to each other. Hence, the segregation caused by the influence of the potential distribution can be most reduced. However, when the influence of the specific gravity is added, cations and anions formed in the EC layer 7 are gradually transferred, and finally, anions and cations are locally present at an upper side and a lower side, respectively, in a vertical direction.

Hence, in this embodiment, the drive device 10 controls the first application period t₁ and the second application period t₂. In this case, when the EC element 1 is set to stand along a vertical direction, the A1 terminal is located at an upper side in a vertical direction than the A2 terminal. When a period (first application period t₁) in which the coloration reaction occurs at the A1 terminal side is set relatively longer than a period (second application period t₂) in which the coloration reaction occurs at the A2 terminal side, the localization of cations caused by the influence of the potential distribution can be controlled so as to be dominant at the A1 terminal side.

As a result, the localization of anions at an upper side in a vertical direction caused by the influence of the specific gravity and the localization of cations caused by the influence of the potential distribution are counteracted with each other, so that the segregation caused by the influence of the specific gravity can be reduced. That is, in this embodiment, when the EC element 1 set to stand along a vertical direction is driven, the potential distribution is controlled so that an oxidation reaction by which the anodic EC material is put in a colored state is dominant at an upper side in a vertical direction as compared to that at a lower side in a vertical direction, so that the segregation caused by the influence of the specific gravity can be reduced.

A method in which the charge amount generated when the A1 terminal of the A1-C1 terminals disposed at an upper side in a vertical direction is used as a plus electrode is set larger than the charge amount generated when the A2 terminal of the A2-C2 terminals disposed at a lower side in a vertical direction is used as a plus electrode is not limited to that described above. For example, as another method, as shown in FIG. 4B, a method in which the voltage crest value is controlled may also be used. In particular, in the second application period t₂ in which the drive voltage is applied between the A2-C2 terminals, +V₂, the absolute value of which is smaller than that of the drive voltage +V₁ applied between the A1-C1 terminals, is applied. The reaction amount of an electrochemical reaction depends on the magnitude of the drive voltage. Hence, by the control of V₁ and V₂, the charge amount generated when the drive voltage is applied between the A1-C1 terminals using the A1 terminal as a plus electrode is set larger than the charge amount generated when the drive voltage is applied between the A1-C1 terminals using the A2 terminal as a plus electrode. As a result, the generation of cations can be controlled so as to be dominant at the A1 terminal side. In addition, the time width and the voltage crest value may also be controlled in combination. In addition, as a preferable structure of this embodiment, the drive voltage is applied between the terminal pairs so that the application periods thereof are not overlapped with each other; however, as long as the advantage of the present disclosure is satisfied, the above application periods may be partially overlapped with each other between the terminal pairs.

Furthermore, when the absorbance, that is, the gray scale, of coloration of the EC element 1 is controlled, the adjustment of the ratio between the application periods t₁ and t₂, the adjustment of the ratio between the drive voltages V₁ and V₂, or the adjustment using both the time width and the voltage crest value may be performed.

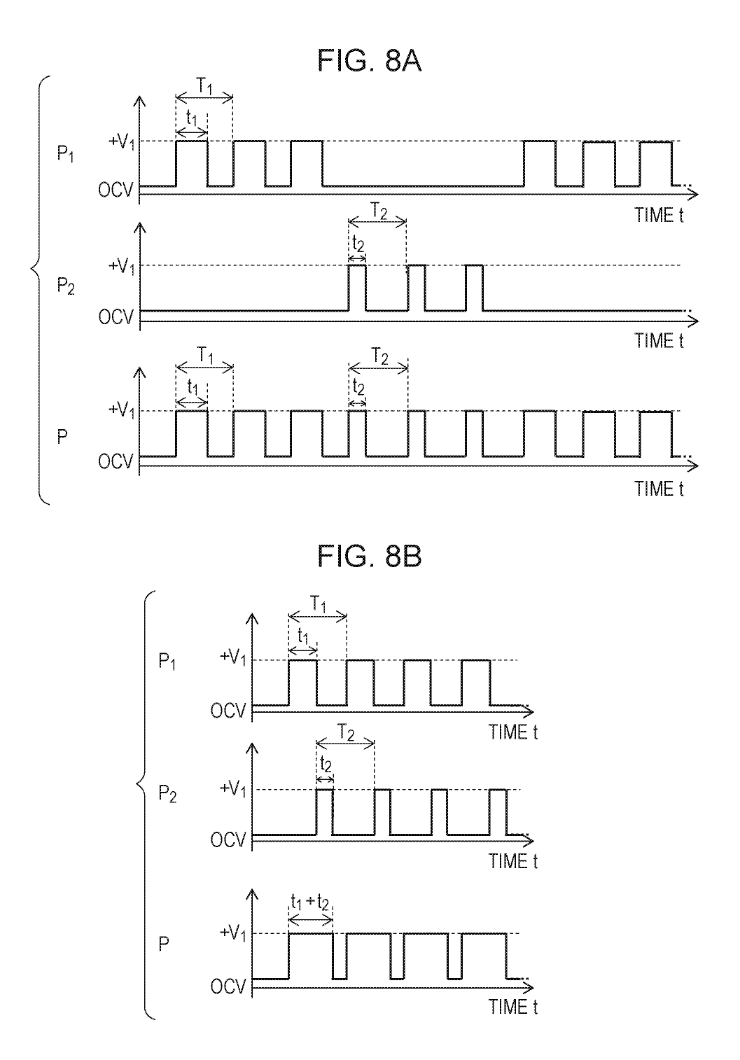

In addition, a method in which the drive voltage is applied between the first terminal pair A1-C1 and between the second terminal pair A2-C2 is not limited to the method described above. For example, there may be used a method in which a step of applying the drive voltage to the first terminal pair A1-C1 a plurality of times and a step of applying the drive voltage to the second terminal pair A2-C2 a plurality of times may be alternately performed. In FIG. 8A, a first drive pulse P₁ and a second drive pulse P₂ in the case described above are shown. As shown in FIG. 8A, the drive device 10 controls so that a step of applying a plurality of pulse trains to the first terminal pair A1-C1 and a step of applying a plurality of pulse trains to the second terminal pair A2-C2 are alternately performed.

In addition, there may also be used a method in which a first drive pulse P₁ and a second drive pulse P₂ as shown in FIG. 8B are applied. In this case, the time width of a first application period t₁ of the first drive pulse P₁ and the time width of a second application period t₂ of the second drive pulse P₂ are controlled, so that the charge amount is controlled. As the entire EC element 1, the sum (t₁+t₂) of the first application period t₁ and the second application period t₂ is applied to the EC element 1.

By the application methods described above, since the time widths of the first application period t₁ and the second application period t₂ are adjusted, the charge amount is controlled. However, the control method of the charge amount is not limited to those described above, and the charge amount can be adjusted when at least one of the time widths of the first application period t₁ and the second application period t₂ and/or at least one of the magnitude of the drive voltage V₁ to be applied to the A1-C1 terminals and the magnitude of the drive voltage V₂ to be applied to the A2-C2 terminals is controlled. Accordingly, the segregation caused by the influence of the specific gravity can be reduced.

In addition, by the application methods described above, when the duty ratio of the drive pulse P₁ and the duty ratio of the drive pulse P₂ are adjusted, the duty ratio of the drive pulse P applied to the EC element 1 can be adjusted. Accordingly, the absorbance of the EC layer 7 can be changed.

In the above application methods, when the application periods t₁ and t₂ are long, at a timing at which the first application period t₁ is switched to the second application period t₂, and at a timing at which the second application period t₂ is switched to the first application period t₁, the absorbance of the EC element 1 may be unfavorably changed in some cases. Hence, in order to reduce the change in absorbance of the EC element 1 during coloration drive, the time width of one cycle T is set to preferably 0.1 Hz or less, more preferably 1 Hz or less, and further preferably 10 Hz or less.

In addition, when a switching frequency f_{ch} (f_{ch}=1/nT) between the terminal pairs is 100 Hz or less, the variation in transmittance in one cycle is unfavorably increased. Hence, the switching frequency f_{ch} between the terminal pairs is preferably set in a range of more than 100 Hz to the drive frequency f. In the application methods shown in FIGS. 4A and 4B, a drive pulse in which the switching frequency f_{ch} is the same as the drive frequency f (f_{ch}=f) is applied.

The charge amount generated when the drive voltage is applied using one terminal of the terminal pair as a plus electrode indicates the charge amount used for the oxidation-reduction reaction of the EC material. That is, the charge amount described above corresponds to the reaction amount of the electrochemical reaction of the EC material. In the EC element 1, the charge amount equivalent to the charge amount used for the electrochemical reaction of the EC material is applied between the pair of electrodes 3 and 5. Hence, the charge amount generated when the drive voltage is applied using one terminal of the terminal pair as a plus electrode can be calculated in such a way that a current flowing between the terminal pair per unit time is measured and then integrated.

According to the EC device 100 of this embodiment, when the EC element set to stand along a vertical direction is used, the segregation can be reduced. In addition, in this embodiment, in order to reduce the segregation, the viscosity of the EC solution contained in the EC layer 7 is not required to be increased, and the segregation can be reduced without remarkably decreasing the response rate of the EC element.

Furthermore, in the EC device 100 of this embodiment, since the segregation can be reduced without changing the polarity of the electrode 3 and the polarity of the electrode 5, the absorbance can be highly precisely controlled.

### Second Embodiment

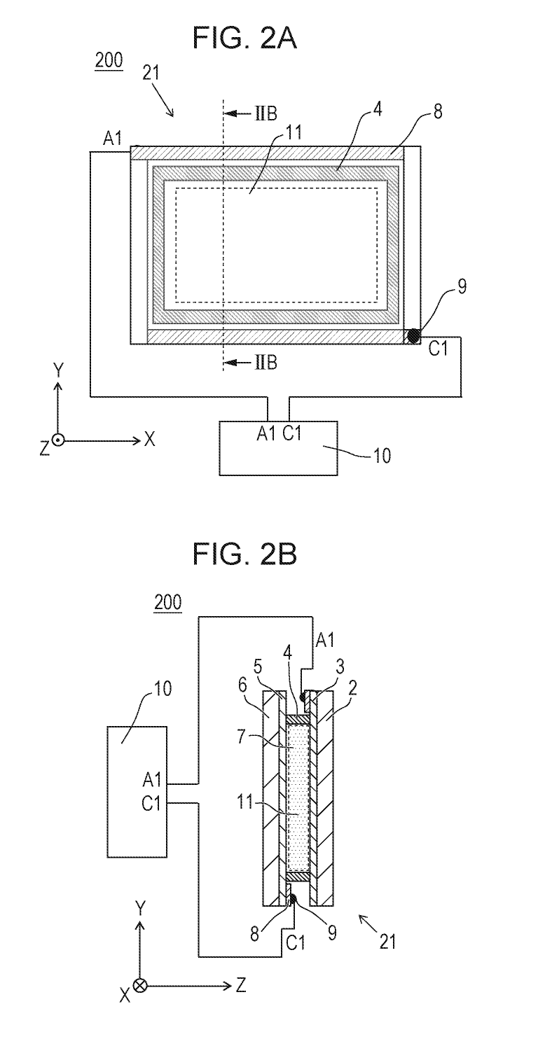

An EC device 200 of this embodiment will be described with reference to FIGS. 2A and 2B. FIGS. 2A and 2B are schematic views each illustrating the structure of the EC device 200. The EC device 200 of this embodiment includes an EC element 21 and a drive device 10. The EC element 21 includes one terminal pair and applies the voltage by the drive device 10 while the polarity of the one terminal pair is alternately changed.

Since the two terminals are connected to the electrodes 3 and 5 with the low resistance wires 8 interposed therebetween, the EC element 1 of the first embodiment has the first terminal pair A1-C1 and the second terminal pair A2-C2. On the other hand, in the EC element 21 of this embodiment, a first terminal 9 is connected to an electrode 3 with a low resistance wire 8 interposed therebetween, and a second terminal 9 is connected to an electrode 5 with another low resistance wire 8 interposed therebetween. The first terminal 9 connected to the electrode 3 and the second terminal 9 connected to the electrode 5 face each other with an effective light region interposed therebetween. That is, in the EC element 21, the first terminal connected to the electrode 3 and the second terminal connected to the electrode 5 form a terminal pair.

Since the other structure is similar to that of the first embodiment, the same reference numerals as those of the first embodiment are used in FIGS. 2A and 2B, and detailed description thereof will be omitted.

In addition, a disposition in which a straight line passing through the first terminal and the second terminal and a straight line orthogonal to a primary surface of the electrode are not parallel to each other is a disposition shown in FIG. 2B. In particular, a straight line passing through A1 and C1 is not parallel to a straight line orthogonal to the primary surface of the electrode 3. The primary surface of the electrode 3 indicates a surface to which A1 is connected. That is, when a lower side of FIG. 2B is a lower side in a gravity direction, A1 is located at an upper side in a gravity direction than C1.

The drive device 10 of this embodiment is a drive device driving the EC element 21. As is the first embodiment, the drive device 10 may be an analog circuit or a computer, such as a CPU. In addition, the drive device 10 preferably includes a relay or a switch circuit which reverses the polarity between the terminals.

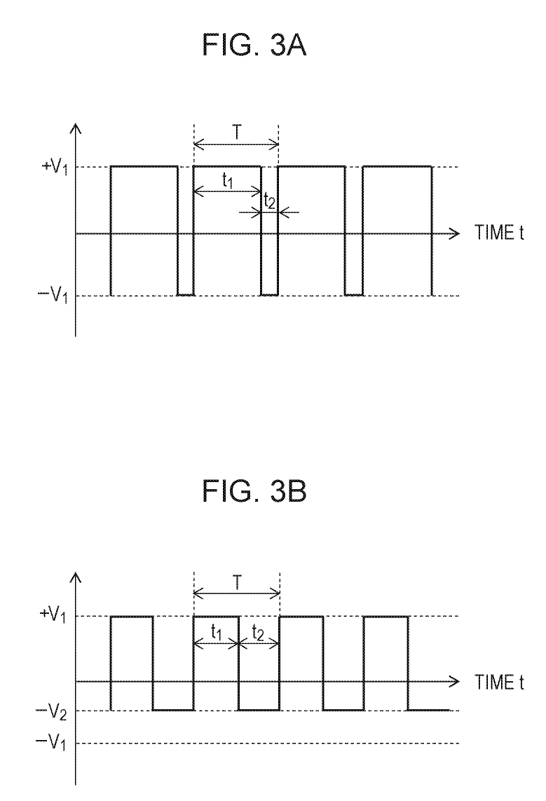

A method for driving the EC element 21 will be described. In this case, the EC element 21 set to stand along a vertical direction is used so that one terminal of the one terminal pair is located at an upper side in a vertical direction as compared to the other terminal. In this case, as shown in FIG. 3A, the drive device 10 alternately applies +V₁ and −V₁, the polarities of which are opposite to each other, between the terminal pair. That is, in the one terminal pair, there may be a case in which one terminal disposed at an upper position in a vertical direction is used as a plus electrode, and one electrode is used as an anode and a case in which the other terminal disposed at a lower position in a vertical direction is used as a plus electrode, and the other electrode is used as an anode. That is, the one terminal pair of the EC element 21 functions as the A1-C1 terminals and the A2-C2 terminals of the EC element 1.

In the case described above, by controlling the time width of a first application period t₁ in which the drive voltage +V₁ is applied and the time width of a second application period t₂ in which the drive voltage −V₁ is applied, the segregation caused by the influence of the potential distribution is controlled so as to counteract the segregation caused by the influence of the specific gravity. As described above, by controlling the application period t₁ of +V₁ and the application period t₂ of −V₁, the drive device 10 controls so that a reaction amount of an anodic organic EC material at an A1 terminal side (upper side in a vertical direction) is larger than a reaction amount of a cathodic organic EC material.

In addition, as described above, a reaction amount of the EC material can be estimated from the charge amount measured by an electrochemical reaction. In addition, alternate application of +V₁ and −V₁ to the terminal pair is equivalent to the case in which the upper terminal and the lower terminal located in a vertical direction are alternately switched to a plus electrode.

As described above, the drive device 10 controls so that the charge amount generated when the terminal of the terminal pair located at an upper side in a vertical direction is used as a plus electrode is larger than the charge amount generated when the terminal of the terminal pair located at a lower side in a vertical direction is used as a plus electrode.

In addition, besides the time width, as shown in FIG. 3B, by controlling the voltage crest value, the segregation caused by the influence of the potential distribution may be adjusted. In this case, for example, in the second application period t₂, −V₂, the absolute value of which is smaller than that of the drive voltage +V₁ in the first application period t₁, is applied. Since the reaction amount of the electrochemical reaction depends on the magnitude of the drive voltage, by the control of V₁ and V₂, the reaction amount of the anodic organic EC material at the A1 terminal side (upper side in a vertical direction) is controlled to be relatively larger than the reaction amount of the cathodic organic EC material. In addition, by using both the time width and the voltage crest value, an arbitrary control may also be performed.

In addition, when the absorbance, that is, the gray scale, of coloration of the organic EC element 21 is controlled, the adjustment of the ratio of t₁ and t₂, the adjustment of the ratio of V₁ and V₂, or the adjustment using both the time width and the voltage crest value may be performed. In addition, in the period t₁ or t₂, the adjustment may also be performed by intermittently applying an application voltage.

When the application periods t₁ and t₂ are long, the absorbance of the organic EC element 21 is changed up and down at a timing at which the period t₁ is switched to the period t₂ and the period t₂ is switched to the period t₁. Hence, in order to reduce the change in absorbance of the organic EC element 21 during coloration drive, the time width of one cycle T is set to preferably 0.1 Hz or less, more preferably 1 Hz or less, and further preferably 10 Hz or less.

In the EC device 200 of this embodiment, one pair of terminals A1 and C1 functions as the first terminal pair and the second terminal pair. Hence, the case in which the A1 terminal is used as a plus electrode and the case in which the C1 terminal is used as a plus electrode are alternately switched, so that the polarity is revered. If the case in which the A1 terminal is used as a plus electrode is switched to the case in which the C1 terminal is used as a plus electrode, the decoloration reaction occurs in the EC layer 7, and the absorbance may be changed in some cases.

According to the EC device 200 of this embodiment, when the EC element set to stand along a vertical direction is used, the segregation can be reduced. In addition, in this embodiment, in order to reduce the segregation, the viscosity of the EC solution contained in the EC layer 7 is not required to be increased, and the segregation can be reduced without remarkably decreasing the response rate of the EC element.

### Third Embodiment

The EC elements and the EC devices according to the embodiments described above may be used for an optical filter, a lens unit, an imaging device, a window material, and the like. In this embodiment, an optical filter, a lens unit, an imaging device, and a window material each including the EC element according to one of the above embodiments will be described.

### [Optical Filter]

An optical filter of this embodiment includes the EC device 100 of the first embodiment. That is, the optical filter of this embodiment includes the EC element 1 and the drive device 10 driving the EC element 1. In addition, the drive device 10 may be integrally assembled with the EC element 1 by direct connection thereto or may be indirectly connected to the EC element 1 with wires interposed therebetween.

The optical filter may be used for an imaging device, such as a camera, and when used for an imaging device, the optical filter may be provided for a main body of the imaging device or a lens unit. Hereinafter, as the optical filter, the case in which a neutral density (ND) filter is formed will be described.

A neutral density filter is required to have a uniform light absorption in a visible light region. In order to realize an ND filter using an organic EC material, materials having different absorption wavelength regions in the visible light region are preferably mixed together so the absorption intensity in the visible light region is uniformed. Since an absorption spectrum obtained by mixing organic EC materials is represented by the sum of absorption spectra of the materials, when materials having appropriate wavelength regions are selected, and the concentrations thereof are adjusted, a uniform light absorption can be realized.

According to a low molecular weight organic EC material, in general, the wavelength region covered by one material is 100 to 200 nm. In order to entirely cover a wavelength of 380 to 750 nm which is the visible light region, at least three types of organic EC materials are preferably used. For example, as the organic EC materials, at least three types of anodic organic EC materials and at least three types of cathodic organic EC materials are preferably used, or at least two types of anodic organic EC materials and at least two types of cathodic organic EC materials are preferably used.

A drive example of the neutral density (ND) filter of this embodiment will be described. In general, the light amount is reduced to ½″ (n is an integer) through the neutral density (ND) filter. When the reduction rate of light amount is ½, the transmittance is changed from 100% to 50%, and when the reduction rate of light amount is ¼, the transmittance is changed from 100% to 25%. In addition, when the transmittance is decreased to ½, from the relationship represented by −LOG (transmittance)=(absorbance), the amount of change in absorbance is 0.3, and when the transmittance is decreased to ¼, the amount of change in absorbance is 0.6. When the light amount is decreased to ½ to 1/64, the amount of change in absorbance may be controlled from 0 to 1.8 by a step of 0.3.

In order to precisely control the absorbance of the EC element 1, an exterior monitor measuring the light amount may be attached as a part of the optical filter.

### [Lens Unit and Imaging Device]

A lens unit of this embodiment includes the optical filter of the embodiment described above and an imaging optical system having a plurality of lenses. The optical filter may be disposed so that light passing through the optical filter is allowed to pass through the imaging optical system or so that light passing through the imaging optical system is allowed to pass through the optical filter.

In addition, the imaging device of this embodiment includes the above optical filter of the present disclosure and a light receiving element receiving light passing through the optical filter.

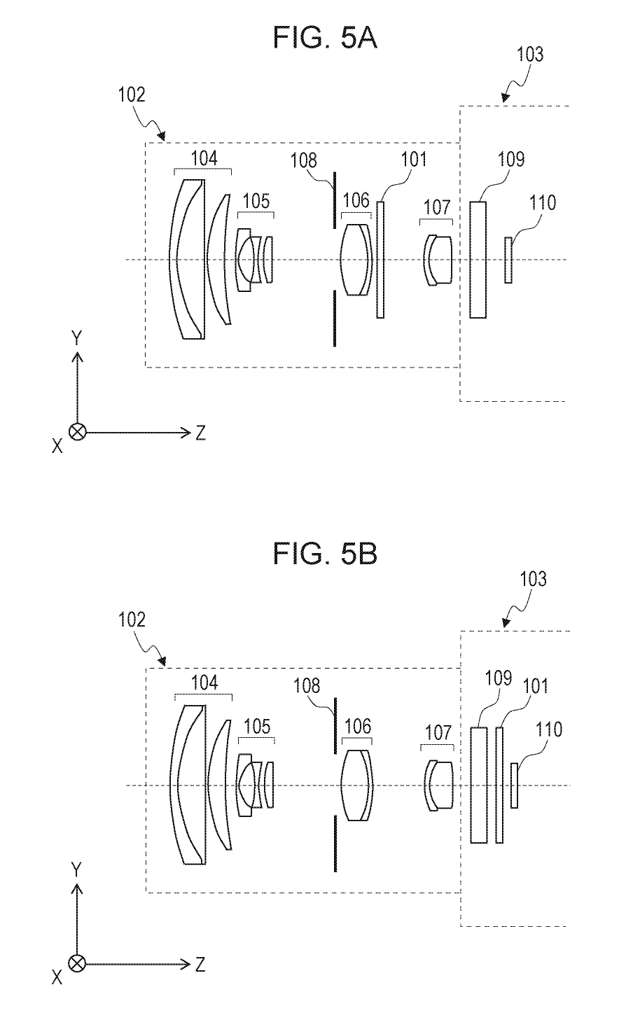

With reference to FIGS. 5A and 5B, the structures of a lens unit and an imaging device using an optical filter 101 of this embodiment will be described. FIG. 5A shows an imaging device 103 including a lens unit 102 which uses the optical filter 101. FIG. 5B is a view illustrating the structure of an imaging device 103 including the optical filter 101. As shown in FIGS. 5A and 5B, the lens unit 102 is detachably connected to the imaging device 103 with a mounting member (not shown) interposed therebetween.

The lens unit 102 is a unit including a plurality of lenses or lens groups. For example, the lens unit 102 shown in FIG. 5A is a rear focus type zoom lens which performs focusing behind a diaphragm. In this lens unit 102, four lens groups, that is, a first lens group 104 having a positive refractive power, a second lens group 105 having a negative refractive power, a third lens group 106 having a positive refractive power, and a fourth lens group 107 having a positive refractive power, are disposed in this order from an object side (from a left side with respect to the plane of the figure). The magnification change is performed by changing the distance between the second lens group 105 and the third lens group 106, and the focusing is performed by moving a part of the fourth lens group 107.

The lens unit 102 includes, for example, a diaphragm 108 between the second lens group 105 and the third lens group 106 and the optical filter 101 between the third lens group 106 and the fourth lens group 107. The lens groups 104 to 107, the diaphragm 108, and the optical filter 101 are disposed so that light passing through the lens unit 102 is allowed to pass therethrough, and the light amount can be adjusted using the diaphragm 108 and the optical filter 101.

In addition, the structure in the lens unit 102 may be appropriately changed. For example, the optical filter 101 may be disposed either in front of the diaphragm 108 (object side) or in the rear of the diaphragm 108 (imaging device 103 side), and in addition, the optical filter 101 may also be disposed either in front of the first lens group 104 or in the rear of the fourth lens group 107. When the optical filter 101 is disposed at a position at which light is converged, for example, the area thereof can be advantageously decreased. In addition, the mode of the lens unit 102 may be appropriately selected, and besides the rear focus type, an inner focus type in which focusing is performed in front of the diaphragm or another method may also be used. In addition, besides the zoom lens, a specific lens, such as a fish-eye lens or a microlens, may also be appropriately selected.

A glass block 109 of the imaging device 103 is a glass block, such as a low-pass filter, a face plate, or a color filter. In addition, a light-receiving element 110 is a sensor portion receiving light passing through the lens unit 102, and an imaging element, such as a CCD or a CMOS, may be used. In addition, a photo sensor, such as a photodiode, may also be used, and an element which obtains information on the intensity or the wavelength of light and outputs the information thereof may be appropriately used.

As shown in FIG. 5A, in the case in which the optical filter 101 is incorporated in the lens unit 102, some constituent component, such as a drive power source, of the drive device 10 may be provided either inside or outside the lens unit 102. When being disposed outside the lens unit 102, the drive device 10 is connected to the optical filter 101 in the lens unit 102 through wires provided therebetween, so that the drive control is performed.

As shown in FIG. 5B, the imaging unit 103 itself may include the optical filter 101. The optical filter 101 may be disposed at an appropriate position in the imaging device 103, and the light receiving element 110 may be disposed so as to receive light passing through the optical filter 101. In FIG. 5B, for example, the optical filter 101 is disposed right in front of the light receiving element 110. When the imaging unit 103 itself incorporates the optical filter 101, since the lens unit 102 itself to be connected to the imaging unit 103 is not required to have the optical filter 101, an imaging device 103 capable of controlling the light amount can be formed using an existing lens unit.

The imaging device as described above may be applied to a product having a light amount adjustment function and a light receiving element in combination. For example, the imaging device as described above may be used for a camera, a digital camera, a video camera, or a digital video camera and may also be applied to a product, such as a mobile phone, a smart phone, a personal computer (PC), or a tablet, incorporating an imaging device.

When the optical filter of the present disclosure is used as a dimming member, the light amount can be appropriately changed by one filter, and the reduction in number of components and the reduction in space can be advantageously realized.

### [Window Material]

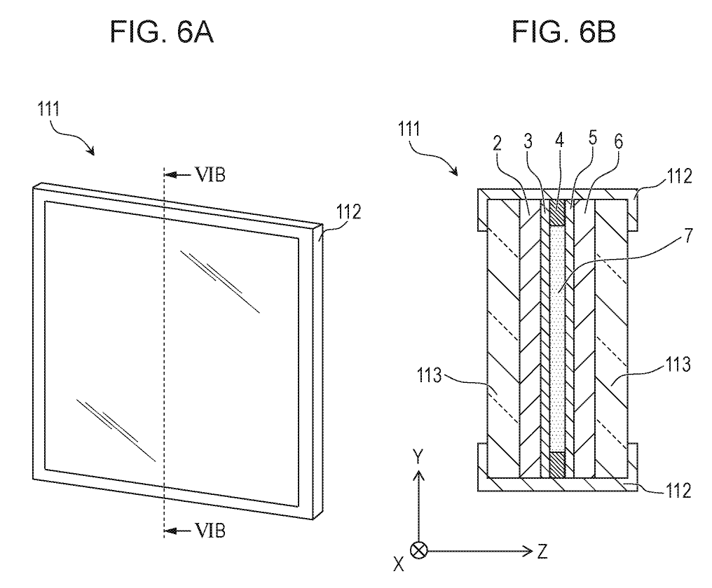

A window material 111 of this embodiment will be described with reference to FIGS. 6A and 6B. FIG. 6A is a perspective view illustrating the structure of the window material of this embodiment, and FIG. 6B is a cross-sectional view taken along the line VIB-VIB of FIG. 6A.

The window material 111 is a dimming window adjusting the transmission amount of light incident thereon. The window material 111 includes an organic EC element 1, transparent plates 113 sandwiching the organic EC element 1, and frames 112 surrounding the entirety for integration or includes an organic EC device 100, transparent plates 113 sandwiching an organic EC element 1, and frames 112 surrounding the entirety for integration. A drive device 10 may be integrated in the frame 112 or may be disposed outside the frame 112 so as to be connected to the EC element 1 through wires.

The transparent plate 113 is not particularly limited as long as having a high optical transmittance, and in consideration of the use as a window, a glass material is preferably used. In this embodiment, although being formed from different constituent members, the EC element 1 and the transparent plate 113 are not limited thereto, and for example, substrates 2 and 6 of the EC element 1 each may be used as the transparent plate 113.

A material of the frame 112 is not particularly limited, and a member which covers at least a part of the EC element 1 and which has an integrated form may be entirely regarded as the frame.

The window material 111 of this embodiment may be used, for example, for the application in which the amount of sun light incident on a room during daytime is adjusted. Besides the amount of sun light, since the heat amount can also be adjusted, the window material 111 of this embodiment may also be used for the control of interior brightness and temperature. In addition, as a shutter, the above window material 111 may also be used for the application in which viewing from the outside into a room is blocked. The window material as described above may also be applied, besides to glass windows of buildings, to windows of vehicles, such as an automobile, an air plane, and a ship, filters for display surfaces of a watch and a mobile phone, and the like.

The electrochromic device according to the embodiment may further include a gravity detection unit detecting the gravity.

The electrochromic element according to the embodiment may be driven so that at an upper side of the electrochromic layer in a gravity direction, the reaction amount of the oxidation reaction is increased. In particular, the polarity of the first electrode and the polarity of the second electrode may be alternately reversed, or different drive signals may be sent to the respective electricity feeding portions using the drive device.

### EXAMPLES

### Example 1

In this example, the behavior of the segregation in the EC device 200 shown in FIGS. 2A, 2B, and 3A was observed. The EC device 200 used in this example was formed as described below.

As the EC element 21, ITO transparent electrodes (electrodes 3 and 5) each having a sheet resistance of 10Ω/□ were formed on respective glass substrates (EAGLE-XG, manufactured by Corning) having a thickness of 0.7 mm, and those substrates were used as a pair of substrates 2 and 6. Since the EC element 21 of this example had a rectangular outer shape, the low resistance wires 8 were formed outside the region 11 each along a long side of the EC element 21. As the low resistance wire 8, a silver thick film was formed to have a sheet resistance of 6.6 mΩ/□ (film thickness: 5 μm) by screen printing using a silver nano-particle paste. In this case, the sheet resistance ratio of the silver wire to the ITO electrode was 1/1,000 or less.

Gap control particles (Micropearl SP (diameter: 50 μm), manufactured by Sekisui Chemical Co., Ltd.) and a thermosetting epoxy resin (Structbond HC-1850, manufactured by Mitsui Chemicals, Inc.) were kneaded together, and the mixture thus prepared was applied onto one of the substrates by a dispensing device to draw a seal pattern having an opening portion to be used for an EC solution injection. Subsequently, this substrate was adhered to the other substrate to form an empty cell having an electrode gap of 50 μm. The gap control particles and the thermosetting epoxy resin corresponded to the spacer 4.

Next, as an EC solution, there was prepared a solution in which an anodic organic EC material, a cathodic organic EC material, and cyanoethyl pullulan (CR-S, manufactured by Shin-Etsu Chemical Co., Ltd.) as a thickening agent were dissolved in a propylene carbonate solution. As the anodic organic EC material, a phenazine compound represented by the following structural formula (1) was used, and as the cathodic organic EC material, a bipyridinium salt compound represented by the following structural formula (2) was used. In addition, the concentration of the anodic organic EC material and that of the cathodic organic EC material were each set to 100 mM, and the addition amount of cyanoethyl pullulan was set to 30 percent by weight with respect to the solvent.

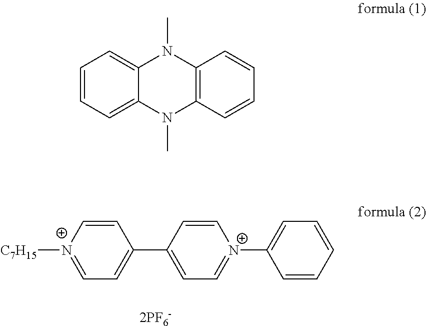

In the cell formed described above so as to have the opening portion, the EC solution was filled by a vacuum injection method, and the opening portion was sealed by a UV curable epoxy resin. Furthermore, lead wires were soldered to the low resistance wires 8, so that the EC element 21 having the A1 terminal and the C1 terminal was formed and was disposed to stand in a vertical direction so that an A1 terminal side was located at an upper side in a vertical direction.

By the use of a drive device 10 having an arbitrary waveform generator (WF1946, manufactured by NF Corp.) and a bipolar power source (HSA4012, manufactured by NF Corp.), the C1 terminal was connected to a ground side, and a rectangular voltage pulse was applied so that the polarity was reversed between the A1-C1 terminals. The application voltage was controlled so that +0.7 V was applied for 5 seconds, and −0.7 V was applied for 1 second. A total drive time for coloration was set to 5,000 seconds.

A measurement sample and electrical wires were introduced in an environmental test chamber manufactured by Horiba Stec Co, Ltd., and the EC element 21 was driven at a control temperature of 80° C.

For the evaluation of the segregation caused by the drive, after driven for 5,000 seconds, the organic EC element 21 was recovered from the environmental test chamber, the terminals were short-circuited to each other so as to put the EC element 21 in a decolored state, and the behavior of remaining coloration was video-recorded.

### Example 2

In this example, the behavior of the segregation was observed when the EC device 100 of the first embodiment shown in FIGS. 1A, 1B, and 4a was used.

Except for that the pair of low resistance wires was formed on each of the electrodes 3 and 5 along the long side direction thereof, and the A1-C1 terminals and the A2-C2 terminals were formed, the EC element 1 of this example had the structure similar to that of the EC element 21 of Example 1. The EC element 1 was disposed to stand in a vertical direction so that the A1 terminal side was located at an upper side than the A2 terminal side.

As the drive device 10, two arbitrary waveform generators (WF1946, manufactured by NF Corp.) and two bipolar power sources (HSA4012, manufactured by NF Corp.) were used, and the C1 terminal and the C2 terminal were each connected to a ground side with a transistor circuit interposed therebetween.

Rectangular wave voltage pulses generated by the arbitrary waveform generators were controlled so as to form reverse phases, when +0.7 V was applied between the A1-C1 terminals, the A2-C2 terminals was set to OCV, and when +0.7 V was applied between the A2-C2 terminals, the A1-C1 terminals was set to OCV. A time of applying +0.7 V between the A1-C1 terminals was set to 80 milliseconds, and a time of applying +0.7 V between the A2-C2 terminals was set to 20 milliseconds. In addition, the other drive environments and evaluation methods were set similar to those of Example 1. In decoloration, all the terminals were short-circuited.

### Comparative Example 1

In this comparative example, −0.7 V was continuously applied between the A1-C1 terminals of the EC element 21 of Example 1. The other drive environments and evaluation methods were set similar to those of Example 1.

### Comparative Example 2

In this comparative example, +0.7 V was continuously applied between the A1-C1 terminals of the EC element 21 of Example 1. The other drive environments and evaluation methods were set similar to those of Example 1.

### Comparative Example 3

In this comparative example, the voltage was alternately applied so that +0.7 V was applied for 50 milliseconds between the A1-C1 terminals of the EC element 1 of Example 2 (OCV between the A2-C2 terminals) and +0.7 V was applied for 50 milliseconds between the A2-C2 terminals (OCV between the A1-C1 terminals). The other drive environments and evaluation methods were set similar to those of Example 1. In decoloration, all the terminals were short-circuited.

### <Behaviors of Segregation of Examples and Comparative Examples>

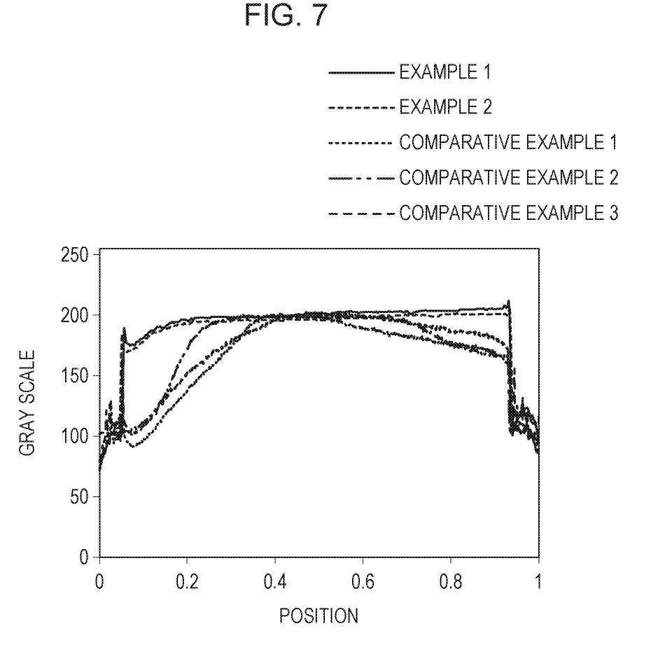

For the observation of the behavior of the segregation of each of the examples and the comparative examples, the behavior of decoloration response was video-recorded. Line profiles of the gray scale in a vertical direction of images each taken after three seconds from short circuit between the terminals were obtained and are collectively shown in FIG. 7.

The gray scale value is obtained from 0 to 255, and as this value is closer to 0, the color remains thick. As the value is closer to 255, the color becomes thin, and an approximately complete decolored state is obtained.

In the line profiles shown in FIG. 7, the horizontal line represents the information on the “position” of the EC element 1 in a vertical direction, a position 0 represents an upper side in a vertical direction, and a position 1 represents a lower side in a vertical direction. In addition, large drops of the gray scale at the two ends each indicate the presence of the spacer 4 (epoxy resin) at the above position. The information of the gray scale in the range between the spacers 4 corresponds to the information on remaining coloration, that is, the information on the segregation.

In Examples 1 and 2, a small drop of the gray scale is present in the vicinity of the spacer 4 located at an upper side in a vertical direction. This small drop corresponds to remaining coloration of the cathodic organic EC material. Although the segregation is slightly present, compared to the results of Comparative Examples 1 to 3, the segregation is significantly reduced. In Comparative Examples 1 to 3, large drops of the gray scale are observed over from an upper side to a lower side in a vertical direction.

In Comparative Example 1, the cathodic organic EC material and the anodic organic EC material are remarkably localized at an upper side and a lower side, respectively, in a vertical direction. The reason for this is believed that the segregations caused by the influences of the potential distribution and the specific gravity are superimposed with each other.

In addition, in Comparative Example 2, although the anodic organic EC material and the cathodic organic EC material are localized at an upper side and a lower side, respectively, in a vertical direction, the degree thereof is lower than that of Comparative Example 1. The reason for this is believed that although the segregation caused by the influence of the potential distribution counteracts the segregation caused by the influence of the specific gravity, the segregation caused by the influence of the potential distribution is slightly dominant.

In Comparative Example 3, the cathodic organic EC material and the anodic organic EC material are localized at an upper side and a lower side, respectively, in a vertical direction. The reason for this is believed that although the segregation caused by the influence of the potential distribution is suppressed, the segregation occurs by the influence of the specific gravity.

Accordingly, it is found that by the EC devices of the above examples, the segregation can be reduced. In the EC devices of the above examples, the voltage is applied so as to induce a relatively large coloration reaction amount of the anodic organic EC material at a terminal side located at an upper side in a vertical direction than that at a terminal side located at a lower side in a vertical direction. As a result, the segregation caused by the influence of the potential distribution and the segregation caused by the influence of the specific gravity can both be reduced. As a result, even if the EC element is driven for a long time while being set to stand along a vertical direction, the segregation of the EC material can be reduced, so that an EC element having a small variation and/or change in absorption spectrum of the EC layer can be provided. In addition, degradation in decoloration response of the EC element after a long time drive can also be reduced.

Although the preferable embodiments have been thus described, the present disclosure is not limited to those embodiments and may be variously changed and/or modified within the scope of the present disclosure.

For example, in the above embodiments and examples, although the rectangular-shaped EC element has been described, the shape thereof is not limited thereto and may be round, oval, or the like.

In the embodiments described above, the charge amount generated when the terminal of the first terminal pair located at an upper side in a vertical direction is used as a plus electrode is set larger than the charge amount generated when the terminal of the second terminal pair located at a lower side in a vertical direction is used as a plus electrode. Accordingly, the segregation caused by the influence of the specific gravity is reduced. As long as the reduction in segregation can be realized, any method other than the driving method and the application method described in the above embodiments may also be used.

The electrochromic device according to the embodiment may further include a gravity detection unit detecting the gravity.

According to the electrochromic element of one aspect of the present disclosure, an electrochromic element in which the charge balance in an electrochromic layer is improved can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-224387 filed Nov. 17, 2016 and No. 2017-168462 filed Sep. 1, 2017, which are hereby incorporated by reference herein in their entirety.

What is claimed is:

1. An electrochromic device comprising:
an electrochromic element including an anode, a cathode, and an electrochromic layer disposed between the anode and the cathode; and
a drive device connected to the electrochromic element,
wherein the anode and the cathode have a plurality of pairs of electricity feeding portions,
the pairs of electricity feeding portions are disposed so that when straight lines passing through the pairs of electricity feeding portions are drawn, the straight lines are intersected with each other, and
the drive device supplies different drive signals to the pairs of electricity feeding portions.

2. The electrochromic device according to claim 1, wherein the electrochromic layer is a solution layer containing an anodic compound and a cathodic compound.

3. The electrochromic device according to claim 2, wherein the drive device supplies a drive signal to the electrochromic element so that a reaction amount of an oxidation reaction is large at an upper side in the electrochromic layer in a gravity direction.

4. The electrochromic device according to claim 3, further comprising a gravity detection unit.

5. The electrochromic device according to claim 3, wherein the drive device more frequently supplies a drive signal instructing to use an electrode of the electrochromic element located at an upper side in a gravity direction as the anode than a drive signal instructing to use the electrode as the cathode.

6. The electrochromic device according to claim 3, wherein when an electrode of the electrochromic element located at an upper side in a gravity direction is used as the anode, the drive device increases an absolute value of a drive voltage.

7. The electrochromic device according to claim 1, wherein among the pairs of electricity feeding portions, one pair thereof is driven.

8. The electrochromic device according to claim 7, wherein when the one pair is driven, the other pair of electricity feeding portions is not driven.

9. The electrochromic device according to claim 1, wherein the anode is provided with two low resistance wires which have a resistance lower than the resistance of the anode and which are connected to a pair of electricity feeding portions, and
the cathode is provided with two low resistance wires which have a resistance lower than the resistance of the cathode and which are connected to a pair electricity feeding portions.

10. An electrochromic device comprising:
an electrochromic element which includes a first electrode, a second electrode, an electrochromic element disposed between the first electrode and the second electrode, a first terminal connected to an end portion of the first electrode, and a second terminal connected to an end portion of the second electrode; and
a drive device reversing the polarity of a voltage to be applied between the first terminal and the second terminal,
wherein a straight line passing through the first terminal and the second terminal and a straight line orthogonal to a primary surface of the first electrode is not parallel to each other, and
a reaction amount of an oxidation reaction generated when the first electrode is used as an anode is different from a reaction amount of an oxidation reaction generated when the second electrode is used as a cathode.

11. The electrochromic device according to claim 10, wherein the drive device supplies a drive signal so that the reaction amount of the oxidation reaction is large at an upper side of the electrochromic layer in a gravity direction.

12. The electrochromic device according to claim 10, wherein a first application period in which the first electrode is used as the anode is longer than a second application period in which the second electrode is used as the anode.

13. The electrochromic device according to claim 10, wherein a first voltage which is an application voltage when the first electrode is used as the anode has an absolute value larger than an absolute value of a second voltage which is an application voltage when the second electrode is used as the anode.

14. The electrochromic device according to claim 10, wherein the first electrode is provided with a low resistance wire having a resistance lower than the resistance of the first electrode and which is connected to the first terminal, and
the second electrode is provided with a low resistance wire having a resistance lower than the resistance of the second electrode and which is connected to the second terminal.

15. The electrochromic device according to claim 10, further comprising a gravity detection unit detecting the gravity.

16. A lens unit comprising:
an optical filter including the electrochromic device according to claim 1; and
an imaging optical system having a plurality of lenses.

17. An imaging device comprising:
an imaging optical system including a plurality of lenses;
an optical filter including the electrochromic device according to claim 1; and
an imaging element receiving light passing through the optical filter.

18. A window material comprising:
a pair of substrates; and
the electrochromic device according to claim 1 disposed between the pair of substrates,
wherein the electrochromic device adjusts the amount of light passing through the pair of substrates.

19. A method for driving an electrochromic element including a pair of electrodes and an electrochromic layer disposed between the pair of electrodes, the method comprising:
driving the electrochromic element so that a reaction amount of an oxidation reaction is increased at an upper side of the electrochromic layer in a gravity direction.
